(19) United States
(12) Patent Application Publication
(10) Pub. No.: US 2022/0096314 A1
(43) Pub. Date: Mar. 31, 2022

(54) Wall Mounted Massage Roller System Including Interchangeable Components

(71) Applicant: Aqushen LLC, Austin, TX (US)

(72) Inventor: Michael Nagy, Austin, TX (US)

(73) Assignee: Aqushen LLC, Austin, TX (US)

(21) Appl. No.: 17/233,393

(22) Filed: Apr. 16, 2021

Related U.S. Application Data
(60) Provisional application No. 63/016,032, filed on Apr. 27, 2020.

(51) Int. Cl. A61H 15/00

(52) U.S. Cl. CPC A61H 15/00; A61H 2201/0126; A61H 2015/0007; A61H 2015/005; A61H 2201/1692; A61H 2201/1676; A61H 2201/0192; A61H 2015/0014

(57) ABSTRACT

A massage roller system is configured to couple massage roller devices to a vertical structure so that a user can utilize the massage devices while standing. The system may include a frame, a roller assembly coupled to the frame, and one or more massage devices coupled to the roller assembly and configured to fit onto the support member. The frame may be coupled to a structure and may include engagement features distributed along a length of the frame. The roller assembly may include a support base configured to couple to the frame and a locking mechanism coupled to the support base and configured to releasably couple to at least one of the engagement features. The roller assembly may include at least one arm extending from the support base and away from the frame and may include a support member coupled to the at least one arm.

### FIELD

The present application is a non-provisional of and claims priority to U.S. Provisional Patent Application No. 63/016,032 filed on Apr. 27, 2020 and entitled “Wall Mount System Including Interchangeable Components,” which is incorporated herein by reference in its entirety.

### FIELD

The present disclosure is generally related to self-massage systems, and more particularly to a wall-mounted, massage roller system that may be mounted on flat surfaces or in or around a corner and that may include interchangeable and adjustable components, such as roller balls, cylinders, hooks, or other components.

### BACKGROUND

Sore muscles from overuse or injury often require treatment. Foam rollers and other types of rollers are sometimes used to stretch and self-massage such muscles, before exercise, after exercise, or both. Typically, such devices are placed on the ground, and the user lays down against the roller and moves while pressing against the device so that the device at least partially supports the user and rolls to stretch and massage the user's muscles. However, some users cannot easily lay down on the floor or get up from a prone position.

### SUMMARY

Embodiments of massage systems are described below that may be used to mount a roller device to a surface, such as a vertical wall, to allow a user to utilize the roller device while standing. The user may lean against the roller device and move his or her body relative to the roller device so that the device partially supports the user and rolls in response to movement of the user to stretch and massage the user's muscles.

In some implementations, the massage system may include a frame and a roller assembly. The frame may be configured to mount to a support structure, such as a wall. The roller assembly may be configured to be adjustable relative to the frame. The roller assembly may include a roller mounting arm that may be configured to releasably secure one or more roller elements to provide a therapeutic experience. A user may place a selected portion of his or her body against the one or more roller elements and may move his or her body relative to the massage system, selectively applying pressure against the one or more roller elements. The user's movement may cause the one or more rollers to rotate about the roller mounting arm, providing one or more of stretching sensation or a massaging sensation to the user's body. In some implementations, the roller assembly may be moved along the frame vertically to a selected height. The roller assembly may include a locking mechanism configured to releasably engage the frame to enable adjustment along the frame and to secure the roller assembly at the selected height.

In some implementations, the frame may be configured as a pair of rails and the roller assembly may be releasably coupled to each of the rails. Each of the rails may include a guide mechanism including locking features configured to engage and secure the roller assembly at a selected elevation. In other implementations, the frame may include a single rail to which the roller assembly may be releasably coupled. The rail may include locking features to configured to engage and secure the roller assembly at a selected elevation.

In some embodiments, a system may include a frame, a roller assembly coupled to the frame, and one or more massage devices coupled to the roller assembly. The frame may be configured to couple to a structure and may include one or more engagement features distributed along a length of the frame. The roller assembly may include a support base configured to couple to the frame and a locking mechanism coupled to the support base and configured to releasably couple to at least one of the one or more engagement features of the frame. The roller assembly may include at least one arm extending from the support base and away from the frame and may include a support member coupled to the at least one arm. The one or more massage devices may be configured to fit onto the support member.

In other embodiments, a system may include a frame and a roller assembly coupled to the frame. The frame may be configured to couple to a structure and including engagement features distributed along a length of the frame. The roller assembly may include a support member configured to receive and secure one or more massage devices. The massage devices may include one or more of a sphere, a cylinder, or a spacer.

In still other embodiments, a system may include a frame and a roller assembly. The frame may be configured to couple to a structure. The frame may include a plurality of engagement features distributed along a length of the frame. The roller assembly may be coupled to the frame. The roller assembly may include a support base, first and second arms, and a support member. The support base may be configured to couple to the frame and a locking mechanism coupled to the support base and configured to selectively couple to one or more of the plurality of engagement features. The first arm may include a first end coupled to the support base and a second end including a release mechanism. The first arm may extend away from the support base. The second arm may include a first end coupled to the support base and a second end including a hinge mechanism. The second arm may extend away from the support base. The support member may include a first end to releasably couple to the release mechanism and a second end coupled to the hinge mechanism. The support member may be configured to receive one or more massage devices.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 is a perspective view of a system including a frame to couple one or more rollers to a support structure, in accordance with certain embodiments of the present disclosure.

FIG. 2A depicts an exploded view of a mounting assembly of the frame of FIG. 1.

FIGS. 2B-2D depict view of the mounting assembly of FIG. 2A including a movable fascia.

FIG. 3 depicts a top view of a corner-mounted frame to attach in a corner of a support structure, in accordance with certain embodiments of the present disclosure.

FIG. 4 depicts a top view of a corner-mounted frame to attach around a corner of a support structure, in accordance with certain embodiments of the present disclosure.

FIGS. 5A-5B depict views of the corner mounting assembly for the corner-mounted frame of FIGS. 3 and 4.

FIG. 6 depicts a top view of a support member of the frame of FIG. 1, 3, or 4, in accordance with certain embodiments of the present disclosure.

FIGS. 7A-7B depict views of a trigger handle, in accordance with certain embodiments of the present disclosure.

FIG. 8A depicts a perspective view of a second embodiment of a system including a frame coupled to a support structure and a roller assembly coupled to the frame, in accordance with certain embodiments of the present disclosure.

FIG. 8B depicts a perspective view of the system of FIG. 8A including mounting brackets to couple the frame to the support structure, in accordance with certain embodiments of the present disclosure.

FIGS. 9A and 9B depicts a front view and a perspective view, respectively, of the system of FIG. 8A and including a roller element coupled to the roller assembly, in accordance with certain embodiments of the present disclosure.

FIG. 10A depicts a top view of an embodiment of the roller assembly of FIGS. 8A-9B and including a roller element coupled to the roller assembly, in accordance with certain embodiments of the present disclosure.

FIGS. 10B and 10C depict a front view and a perspective view of the roller assembly of FIG. 10A with the roller element removed.

FIG. 11A depicts a cross-sectional view of the roller assembly taken along line 11-11 in FIG. 10B.

FIG. 12A depicts a top view of a roller assembly including a roller mounting arm pivoted to allow for selected mounting of a roller element, in accordance with certain embodiments of the present disclosure.

FIG. 12B depicts a perspective view of the roller assembly of FIG. 12A showing a release mechanism to release an end of the roller mounting arm to enable selective installation of a roller element on the roller mounting arm.

FIG. 13A depicts a rear view of an embodiment of a roller mounting assembly including a locking mechanism configured to releasably engage elevation locking features of a frame, in accordance with certain embodiments of the present disclosure.

FIG. 13B depicts an embodiment of a system including the elevation locking features of the frame, in accordance with certain embodiments of the present disclosure.

FIG. 14A depicts a side view of the system of FIGS. 8A-13B with a handle of a locking mechanism in a locked state, in accordance with certain embodiments of the present disclosure.

FIG. 14B depicts a cross-sectional view of the system of FIG. 14A taken along line B-B.

FIG. 15A depicts a front view of the system including the frame and a roller assembly coupled to the frame by a locking mechanism with a handle of the locking mechanism in an unlocked state, in accordance with certain embodiments of the present disclosure.

FIG. 15B depicts a side view of the system of FIG. 15A.

FIG. 15C depicts a cross-sectional view of the system of FIG. 15B taken along line C-C.

FIGS. 16A-16E depict embodiments of roller elements including roller balls, in accordance with certain embodiments of the present disclosure.

FIG. 17A depicts a foam roller accessory that can be used with any of the systems of FIGS. 1-15C, in accordance with certain embodiments of the present disclosure.

FIG. 17B depicts a cross-sectional view of the foam roller accessory of FIG. 17A taken along line B-B, in accordance with certain embodiments of the present disclosure.

FIG. 18A depicts a side view of a force point roller assembly including a C-clamp and détente pin that can be used with any of the systems of FIGS. 1-15C, in accordance with certain embodiments of the present disclosure.

FIG. 18B depicts a side view of a clip or carabiner assembly that can be used with any of the systems of FIGS. 1-15C, in accordance with certain embodiments of the present disclosure.

FIG. 19 is a flow diagram of a method of installing a system including a supporting assembly to secure and support one or more roller devices, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the particular form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the work “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

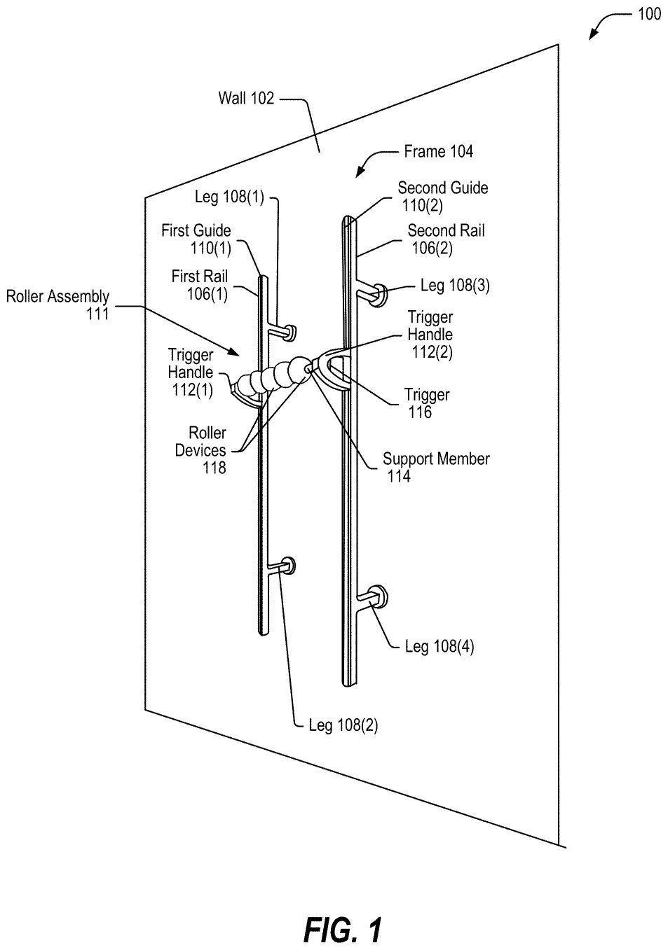

Embodiments of a self-massage system are described below that include a frame that may be mounted to a structure, such as wall. The frame may be formed from a pair of rails, which may be coupled to one another by a supporting assembly. The supporting assembly may be coupled to the rails by a pair of handles. Each handle may include a release mechanism accessible by a user to release the handle from the rail to allow for movement of the handles. One implementation of the system is described below with respect to FIG. 1.

FIG. 1 is a perspective view of a system 100 including a frame 104 configured to couple one or more rollers to a support structure, in accordance with certain embodiments of the present disclosure. The frame 104 may be coupled to a support structure, such as a wall 102, one or more posts or studs, or another structure that is strong enough to support the frame 104 and to withstand pressure applied by a user.

In some implementations, the frame 104 may include one or more rails 106. In the illustrated example, the frame 104 may include a pair of rails including a first rail 106(1) and a second rail 106(2), which may be spaced apart by a distance corresponding to a length of a support member 114 of a roller assembly 111. The first rail 106(1) may be coupled to the wall 102 by a plurality of legs 108, including a first leg 108(1) and a second leg 108(2). The second rail 106(2) may be coupled to the wall 102 by a plurality of legs 108, including a third leg 108(3) and a fourth leg 108(4).

Each rail 106 may include a guide 110, which may extend along the rail 106 from a top portion to a bottom portion. The guide 110 include a slot to receive a portion of a handle or other coupling mechanism associated with the support member 114. The slot of the guide 110 may include one or more engagement features distributed along a length of the frame 104. The engagement features may include openings, slots, ridges, teeth, or other features configured to engage corresponding features in the trigger handles 112. The first rail 106(1) may include a first guide 110(1) to engage a first trigger handle 112(1) and the second rail 106(2) may include a second guide 110(2) to engage a second trigger handle 112(2).

The roller assembly 111 may include handles 112 configured to couple to the rails 106 and to releasably secure the roller assembly 111 at a selected elevation by selectively engaging the guides 110. The roller assembly 111 may further include a support member 114, which may be configured to secure one or more roller devices 118. The support member 114 may extend between the first handle 112(1) and the second handle 112(2). The first and second handles 112 may couple the support member 114 to the rails 106. Each handle 112 may include a control option, such as a trigger 116, which may be engaged by a user to release the respective trigger handle 112 from the openings or teeth of the guides 110 to allow the user to slide the trigger handle 112 along the guides 110 to position the support member 114 at a selected height along the rails 106. Other implementations are also possible.

In the illustrated example, a plurality of roller devices 118 are positioned along the support member 114. In this example, multiple roller devices 118 may be positioned along the support member 114. However, in other implementations, one or more roller devices 118 may be positioned on the support member 114. In some instances, one or more spacers may also be positioned on the support member 114 to space the roller devices 118 apart from one another and optionally to space the roller devices 118 away from the trigger handles 112. Other implementations are also possible.

Depending on the implementation, the roller devices 118 may be formed from a hard plastic or rubber material that is relatively incompressible, formed from a foam material, or formed from a composite material. Other implementations are also possible.

While the roller devices 118 depicted in FIG. 1 may be hard spherical devices configured to rotate about the support member 114, other shapes and other features are also possible. For example, the roller devices 118 may be spheres, cylinders, spirals, or other roller devices. In other examples, the roller devices 118 may be replaced with hooks, clasps, or other components. The hooks or clasps, for example, may be used to secure an end of an elastic band. In an example, each spherical roller device 118 may include bumps, spikes, or other features. In another example, the roller device 118 may be a cylindrical device, a spiral device (such as a corkscrew shape), or another shape selected to provide a desired massage effect.

Additionally, though the roller devices 118 are depicted as being substantially the same, the roller devices 118 on the support member 114 may vary in diameter, shape, relative hardness, and so on. In an example, a first roller device 118(1) may be formed from a relatively soft foam material, and adjacent roller device 118(2) may be formed from a relatively hard rubber material. In this example, the first roller device 118(1) may have a larger diameter than the second roller device 118(2). Other variations are also possible.

In another example, a spherical roller may be paired with a cylindrical roller and with one or more spacers. In another example, a single spherical roller may be used in conjunction with two or more spacers. In another example, multiple spherical rollers may be used and may be separated from one another by spacers. In yet another example, a first spherical roller (with a groove pattern) may be used in conjunction with a second spherical roller having bumps or spikes. Other combinations are also possible.

In some implementations, one of the handles 112 may be accessed to release an end of the support member 114 and the other handle 112 may include a hinge or other feature, which may allow the support member 114 swing or hinge to an open position to allow for removal or installation of selected roller devices 118. Other implementations are also possible.

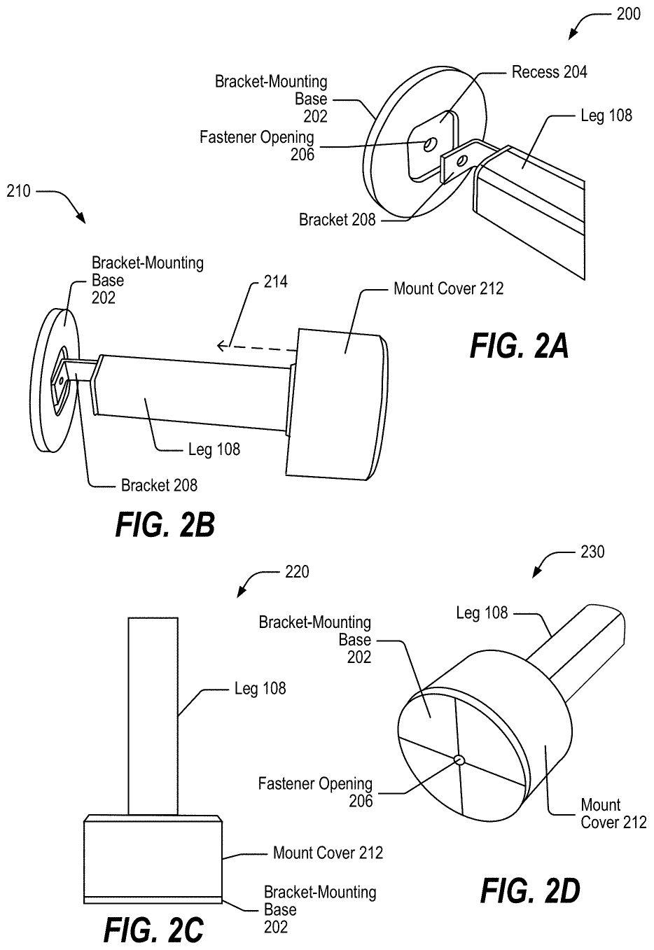

In some implementations, the legs 108 may include mounting assemblies to facilitate coupling of the legs 108 to the wall 102. An example implementation is described below with respect to FIGS. 2A-2D.

FIG. 2A depicts an exploded view of a mounting assembly 200 of the frame of FIG. 1. The mounting assembly 200 may include the leg 108 of the frame 104. Additionally, the mounting assembly 200 may include a bracket-mounting base 202 configured to be fixed to a structure, such as the wall 102. The bracket-mounting base 202 may include a recess 204 and a fastener opening 206 within the recess 204. The leg 108 may include a bracket 208 (or flange) sized to fit within the recess 204 and to couple the leg 108 to the bracket-mounting base 202.

FIGS. 2B-2D depict view of the mounting assembly 200 of FIG. 2A including a movable fascia or mount cover 212. In FIG. 2B, the view 210 depicts the leg 108 from a side view with the bracket 208 coupled to the bracket-mounting base 202. In some implementations, the base 202 may be screwed or otherwise fastened to the support structure, and the bracket 208 may be screwed or otherwise fastened to the base 202 through a fastener opening 206.

In some implementations, the fascia or mount cover 212 may be provided which may fit over the leg 108 and which may be moved in the direction of arrow 214 toward the bracket-mounting base 202 to operate as a cover. The mount cover 212 may couple to the bracket-mounting base 202 to form an enclosure that may obscure the attachment of the bracket 208 and the base 202. Other implementations are also possible.

In FIG. 2C, the view 220 depict a side view of the mounting assembly 200 with the facia or mount cover 212 coupled to the bracket-mounting base 202. In this example, the mount cover 212 may click onto or otherwise releasably lock over the bracket-mounting base 202. Other implementations are also possible.

FIG. 2D shows a bottom perspective view 230 of the mounting assembly 200 including a bottom view of the fastener opening 206 extending through the bracket-mounting base 202.

In the illustrated example of FIGS. 2B-2D, the mount cover 212 is shown to provide a cover for the attachment features, protecting the fasteners from unintentional contact or access to the fasteners. Further, the fascia 212 may cover any sharp edges associated with the attachment.

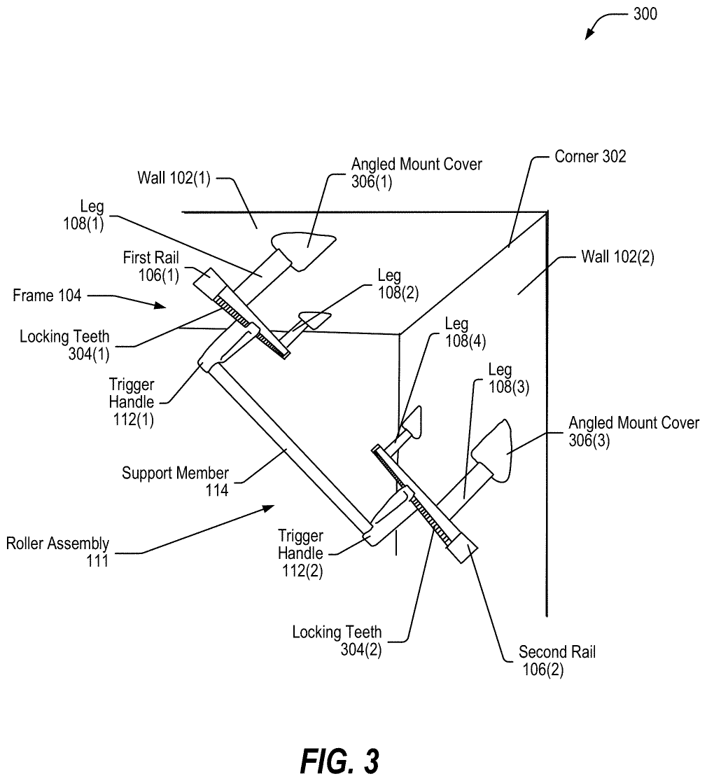

While the embodiments shown in FIGS. 2A-2D represent a system that may be mounted to a flat surface, the same system may be adapted to be mounted in a corner. One possible implementation of the system mounted in a corner is described below with respect to FIG. 3.

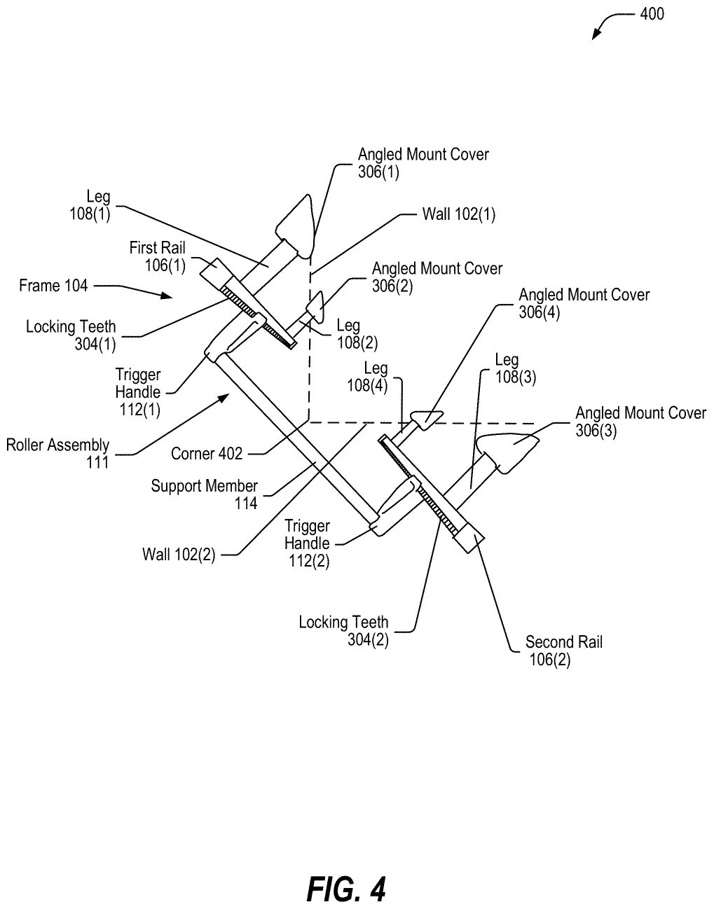

FIG. 3 depicts a top view 300 of a corner-mounted frame 104 to couple one or more rollers to a support structure, such as in a corner formed by walls 102, in accordance with certain embodiments of the present disclosure. It should be appreciated that the frame may be mounted to a planar surface (as shown in FIG. 1, in a corner as shown in the view 300, or around a corner (as shown in FIG. 4). In this example, the support structure may include a first wall 102(1) and a second wall 102(2) coupled at a corner 302.

In this example, the rails 106 may include locking points or grooves 304, which may be located along the front or sides of the rails 106. In other implementations, the locking points or grooves 304 may be along an outer surface of the rails 106 instead of within a guide 110 (or slot) as depicted in FIG. 1.

In this example, each of the legs 108 may be coupled to one of the walls 102, and the mounting-bracket base 202 may be enclosed or obscured by an angled mount cover 306. In this example, the angled mount cover 306 may be angled at approximately 45 degrees to mate with the adjacent walls 102 on opposite sides of the corner 302. Other implementations are also possible. The bracket 208 (in FIG. 2) may be bent or may be formed at a 45-degree angle to mate with the mounting-bracket base 202, and the angled mount cover 306 may fit over a portion of the leg 108 and the bracket 208, and may couple to the mounting-bracket base 202.

While the example of FIG. 3 depicts the system 300 mounted into the inside of a corner 302 forming a 90-degree angle where two walls 102(1) and 102(2) join, the system can also be mounted around the outside of a corner that forms a 270-degree angle. An example is depicted in FIG. 4 in which the system is mounted around the outside of the corner.

FIG. 4 depicts a top view 400 of a corner-mounted frame 104 to attach around a corner 402 of a support structure, such as walls 102, in accordance with certain embodiments of the present disclosure. The view depicts the same corner-mounted frame 104 as that shown in FIG. 3, except that the angled mount covers 306 are rotated to allow the angled mount covers 306 to match to the surface of the wall 102 when the frame 104 is coupled around a corner of the wall 102. In some implementations, one or more of the legs 108, underlying brackets 208, or the angled mount covers 306 may be rotated as well to fit the angles of the walls 102.

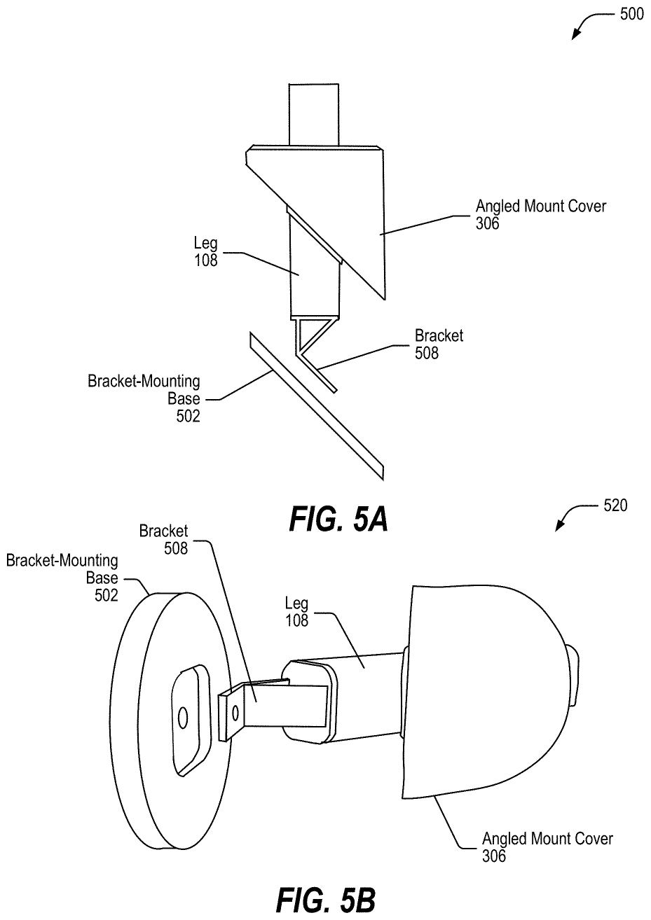

FIGS. 5A-5B depict views of the corner mounting assembly for the corner-mounted frame of FIGS. 3 and 4. In FIG. 5A, a side view 500 is shown that includes the leg 108 with an angled mount cover 306. The leg 108 may be coupled to the bracket-mounting base 502 by an angled bracket 508, that forms a forty-five-degree angle relative to the longitudinal axis of the leg 108. In this example, the angled bracket 508 is an implementation of the bracket 208 in FIG. 2, except that the bracket is angled at 45 degrees.

The bracket-mounting base 502 may be implemented as a disk-shape that is configured to engage the angled mount cover 306. In some implementations, the edge of the bracket-mounting base 502 may be angled at approximately 45-degrees to mate with the angled mount cover 306. In some implementations, the angled-mount cover 306 may include a clip, a ridge, or a lip configured to engage the edge of the bracket-mounting base 502 to secure the angled-mount cover 306 to the base 502.

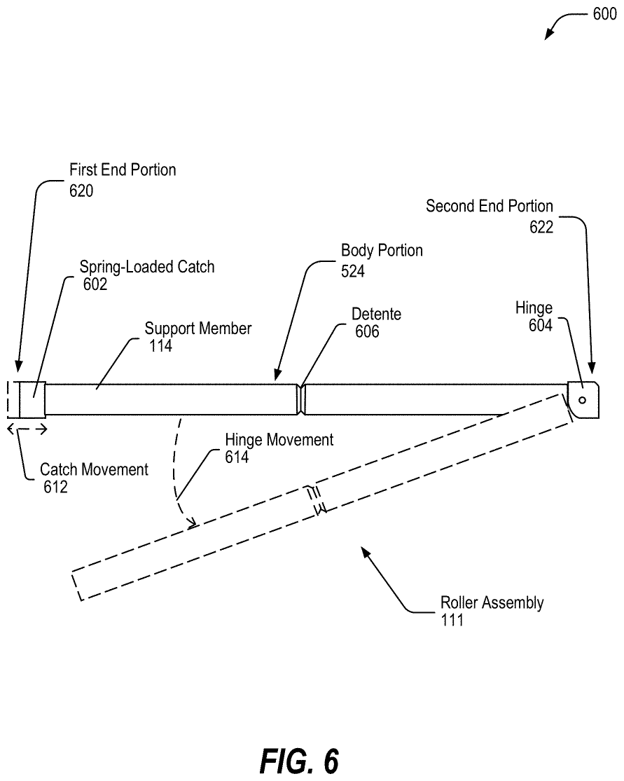

FIG. 6 depicts a top view 600 of a support member 114 of the frame 104 of FIG. 1 or 3, in accordance with certain embodiments of the present disclosure. The support member 114 may be coupled to a first handle 112(1) by a spring-loaded catch 602 and to a second handle 112(2) by a hinge 604 (or vice versa). The support member 114 may be disengaged from the first handle 112(1) by moving the spring-loaded catch 602 (as indicated by the catch movement arrow 612) to disengage a first end of the support member 114. Alternatively, the spring-loaded catch 602 may be rotated to disengage the support member 114. The support member 114 may then pivot about the hinge 604 (as indicated by the hinge movement arrow 614) to make an end of the support member 114 accessible for insertion of a roller device 118 or other component. For example, the user may slide one or more roller devices 118 (spacers, foam rollers, balls, or other devices) onto the detached end of the support member 114. The support member 114 may then be pivoted toward the spring-loaded catch 602 and the end may be reattached via the spring-loaded catch 602 to secure the support member 114.

In some implementations, the support member 114 may include a détente 606, which may be centered on the support member 114. The détente 606 may provide an alignment feature for aligning the roller devices 118 on the support member 114. In some implementations, the détente 606 may engage a corresponding feature on an interior surface of the roller device 118 (or other component), which may prevent the roller device 118 from shifting along the support member 114. Other implementations are also possible.

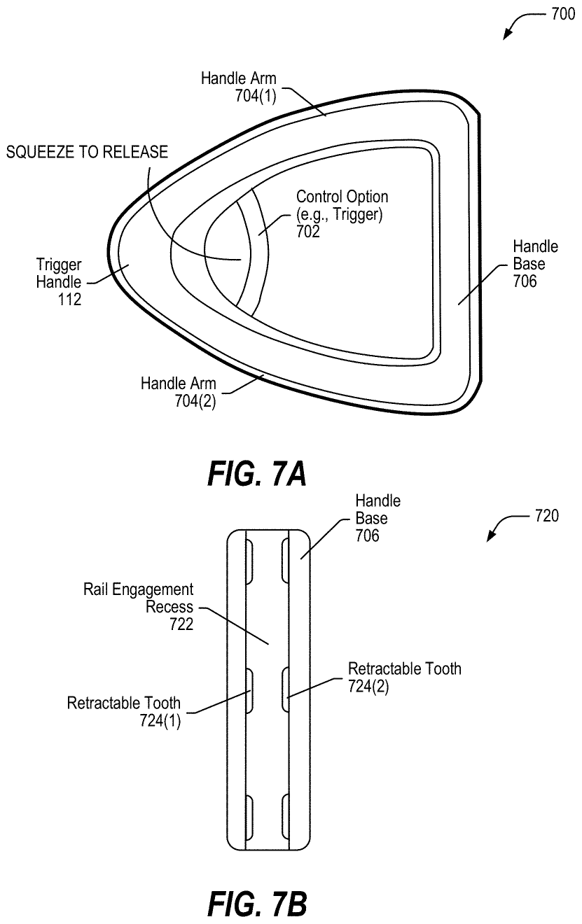

FIGS. 7A-7B depict views of a trigger handle 112, in accordance with certain embodiments of the present disclosure. In FIG. 7A, the trigger handle 112 is shown to include a pair of handle arms 704 connected to a handle base 706. The trigger handle 112 may include a control option 702, such as a squeezable trigger, a button, or another feature. In this example, the control option 702 may include a trigger element that can be pulled by the user to retract one or more retractable teeth 724 (shown in FIG. 7B) to enable selective engagement or disengagement of the handle base 607 to the rail 106 or guide 110, which may allow the user to move the handle base 706 along the rail 106 or guide 110 to a selected elevation.

In FIG. 7B, a bottom view 720 of the handle base 706 is shown. The handle base 706 may include a rail (or guide) engagement recess 722 (or extension, depending on the implementation), which may be sized to receive one or more of the rail 106 or the guide 110. The handle base 706 may also include a plurality of retractable teeth 724 positioned within the recess 722 and configured to engage openings, teeth, slots, or grooves associated with one or more of the rail 106 or the guide 110.

In some implementations, retractable teeth 724 may be retracted in response to pulling of the control option 702 and may extend when the control option 702 is released. In some implementations, the retractable teeth 724 may be biased by a spring mechanism that is internal to the handle base 706. The spring mechanism may cause the retractable teeth 724 to extend to engage the openings, teeth, slots, or grooves in the rail 106 or associated with the guide 110. Thus, a user may interact with the control option 702 to release the trigger handle 112 to enable movement of the trigger handle 112 along the rail 106. Other implementations are also possible.

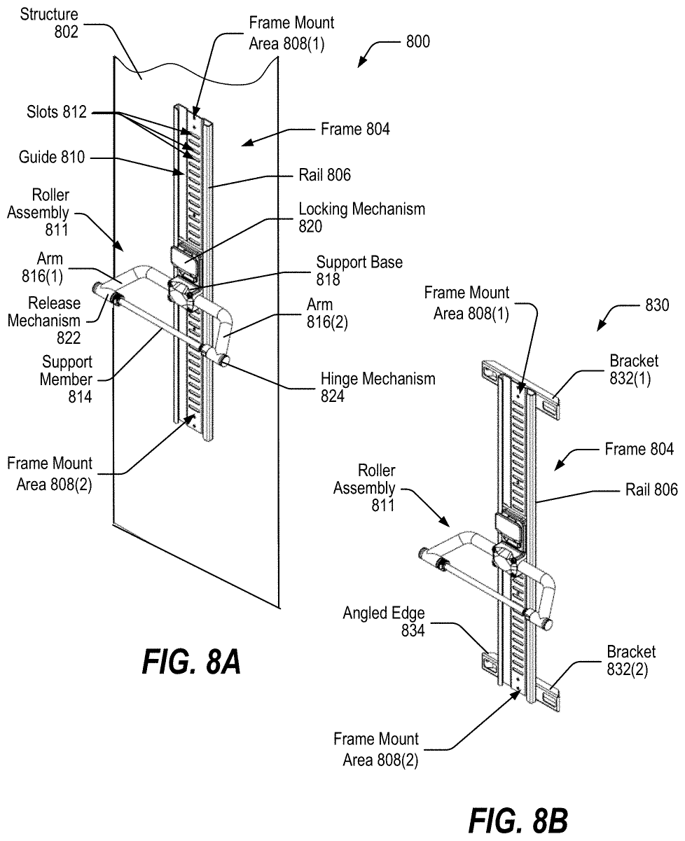

While the embodiments of the system described above with respect to FIGS. 1-7B describe an implementation including a pair of rails or guides 110 and the roller assembly 111 coupled between the guides 110, in some implementations a single rail or guide may be provided, and the roller assembly 111 may be configured to releasably couple to the single rail or guide. An implementation that includes a frame having a single rail or guide and a roller assembly that is configured to couple to frame is described below with respect to FIGS. 8A-16C.

FIG. 8A depicts a perspective view of a second embodiment of a system 800 including a frame 804 coupled to a support structure 802 and a roller assembly 811 coupled to the frame 804, in accordance with certain embodiments of the present disclosure. The frame 804 may include a rail 806, which may provide a c-shaped frame structure having recesses along opposing edges to provide channels into which the roller assembly 811 may slide. The frame 804 may also include a plurality of slots (ridges or openings) 812 configured to engage the roller assembly 811 at a selected elevation. The frame 804 may include frame mount areas 808, which may include openings to receive fasteners (such as screws or nails) to secure the frame 804 to the structure 802.

The roller assembly 811 may include a support member 814 coupled between a pair of arms 816(1) and 816(2), which may extend from a support base 818. The roller assembly 811 may include a locking mechanism 820, which may selectively engage slots 812 within the guide 810 to secure the roller assembly 811 at a selected elevation. The support member 814 may include a first end coupled to a hinge mechanism 824 of the second arm 816(2) and may include a second end that may be releasably coupled to the arm 816(1) by a release mechanism 822. In some implementations, the release mechanism 822 may include a rotating element that may be turned by a user to release the second end of the support member 814.

The support member 814 may be an implementation of the support member 114. In this example, the support member 814 may be configured to secure one or more roller devices 118, such as roller balls, foam rollers, or other devices. Further an elevation of the roller assembly 811 may be adjusted along the frame 804 to provide the roller devices 118 at a selected height.

In the illustrated example, the frame 804 may be mounted to a structure 802, such as a wall or other flat surface. The arms 816 may extend from the support base 816 and may extend laterally outside of the width of the frame 804 and may curve away from the structure 802. The support member 814 may extend between the ends of the arms 816. The curvature of the arms 816 may provide a space between the support member 814 and the support base 818. The space may be sufficient to allow a roller device to turn on the support member 814 without contacting the arms 816 or the support base 818.

In the example of FIG. 8A, the frame 804 may be coupled directly to the structure 802. In other implementations, one or more brackets may be provided that may be used to couple the frame 804 to a structure 802. One example of the frame 804 including a bracket to couple to a structure 802 is described below with respect to FIG. 8B.

FIG. 8B depicts a perspective view 830 of the system 800 of FIG. 8A including mounting brackets 832 to couple the frame 804 to the support structure 802, in accordance with certain embodiments of the present disclosure. In this example, the frame mount area 808 may be configured to engage a portion of the bracket 832. The bracket 832 may include angled edges 834, which may engage a support 802. The angled edges 834 may enable mounting of the frame 804 in a corner. Other implementations are also possible.

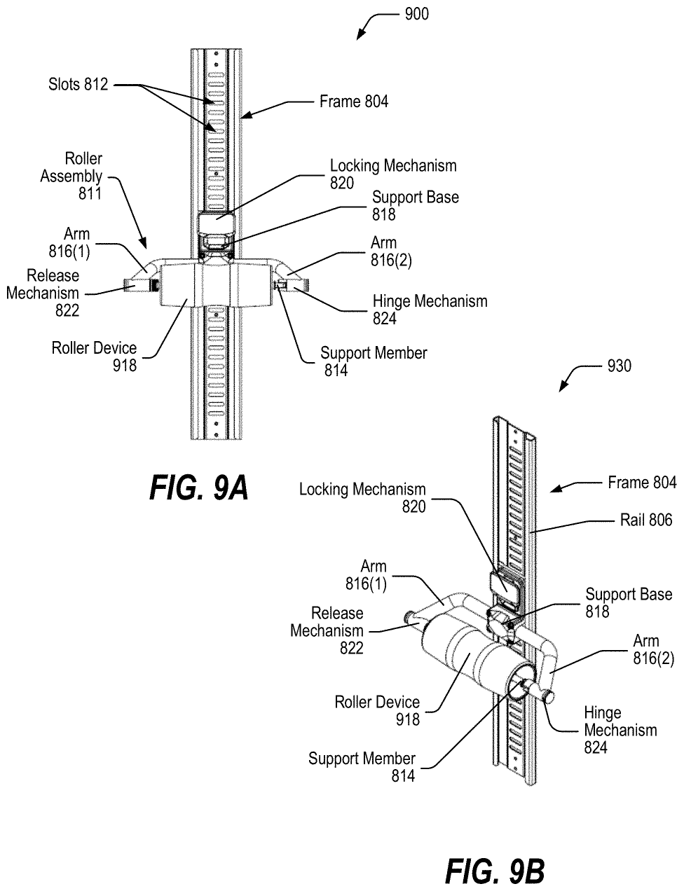

FIGS. 9A and 9B depicts a front view 900 and a perspective view 930, respectively, of the system 800 of FIGS. 8A and 8B and including a roller element 918 coupled to the roller assembly 811, in accordance with certain embodiments of the present disclosure. In FIG. 9A, the frame 804 includes a plurality of slots 812, which may be engaged by the locking mechanism 820 to secure the roller assembly 811 at a selected height along the frame 804. In this example, the system 900 includes all the elements of the system 800 in FIG. 8. Additionally, the roller assembly 811 includes a roller device 918. The roller device 918 may be an implementation of one of the roller devices 118 described with respect to the system of FIG. 1.

In this example, the roller device 918 may be coupled to the support member 814. The roller device 918 may be a foam roller that may be configured to rotate about the support member 814. In some implementations, the foam roller may include a sleeve or other feature configured to define a lumen or opening sized to fit onto the support member 814 and to enable free rotation of the foam roller about the support member 814. The roller device 918 may be rigid or partially compressible to provide a desired massage effect when a user leans against and moves relative to the roller device 918, causing the roller device to spin on the support member 814.

In some implementations, the locking mechanism 820 may include a handle and a flange with a guide engagement mechanism configured to engage one or more slots 812 of the frame 804 to secure the roller assembly 811 at a selected position along the frame 804. In some implementations, a user may pull the handle to release the roller assembly 811 and then may move the roller assembly 811 along the frame 804 to a selected position. Once the roller assembly 811 is at a desired position, the user may push the handle to lock the roller assembly 811 to the frame 804 at the selected position.

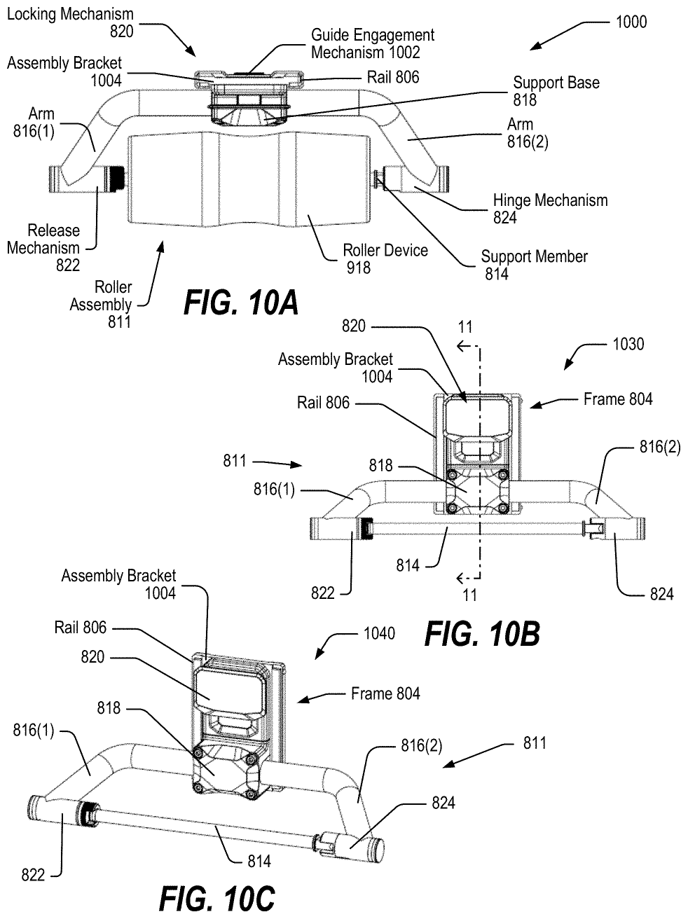

FIG. 10A depicts a top view 1000 of an embodiment of the roller assembly of FIGS. 8A-9B and including a roller device 918 coupled to the roller assembly 811, in accordance with certain embodiments of the present disclosure. The roller assembly includes a locking mechanism 820 including a guide engagement mechanism 1002, which may selectively engage one or more of the slots 812 of the guide 810.

In this example, the frame 804 includes a rail 806, which includes c-shaped channels that extend around edges of an assembly bracket 1004. The bracket 1004 may be coupled to the locking mechanism and the support base 818 and may slide into the c-shaped channels.

FIGS. 10B and 10C depict a front view 1030 and a perspective view 1040 of the roller assembly of FIG. 10A with the roller element removed. In these examples, the assembly bracket 1004 is visible between a top edge of the locking mechanism 820 and the c-shaped channel of the rail 806. The c-shaped channel of the rails 806 may hold the roller assembly 811 against a rear portion of the frame 804 while the guide engagement mechanism 1002 may engage the slots or openings 812 in the guide 810 to secure the roller assembly at a selected elevation along the frame 804.

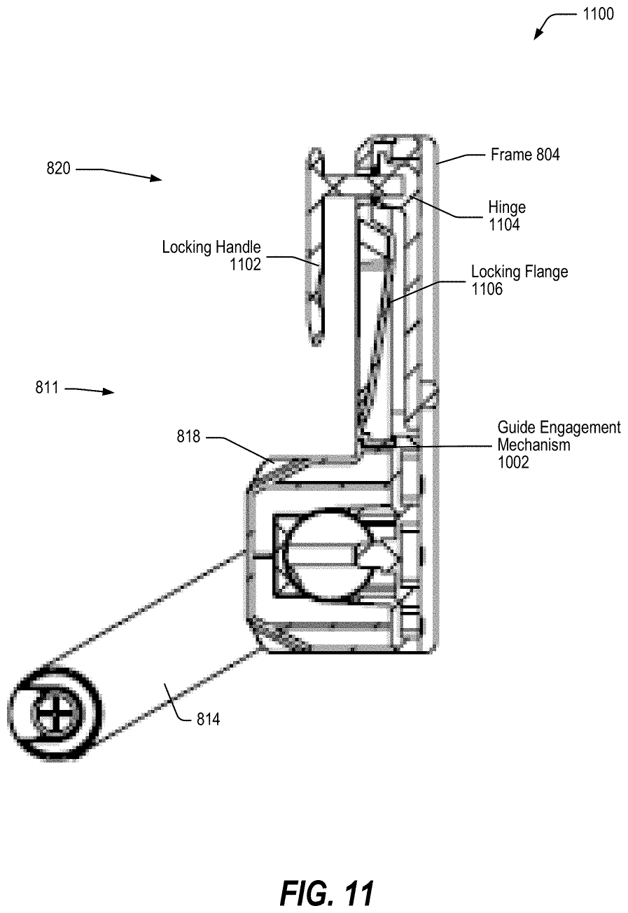

FIG. 11 depicts a cross-sectional view 1100 of the roller assembly 811 taken along line 11-11 in FIG. 10B. The locking mechanism 820 includes a locking handle 1102 coupled to a locking flange 1106 by a hinge 1104. By pulling the locking handle 1102, the hinge 1104 may turn, moving the locking flange 1106. An end of the locking flange 1106 that is opposite the hinge 1104 may include the guide engagement mechanism 1002, which may extend into a slot 812 of the guide 810 of the frame 804. In some implementations, the support base 818 may also include a guide engagement feature, which may extend into or through one or more of the slots 812 in the frame 804. Other implementations are also possible.

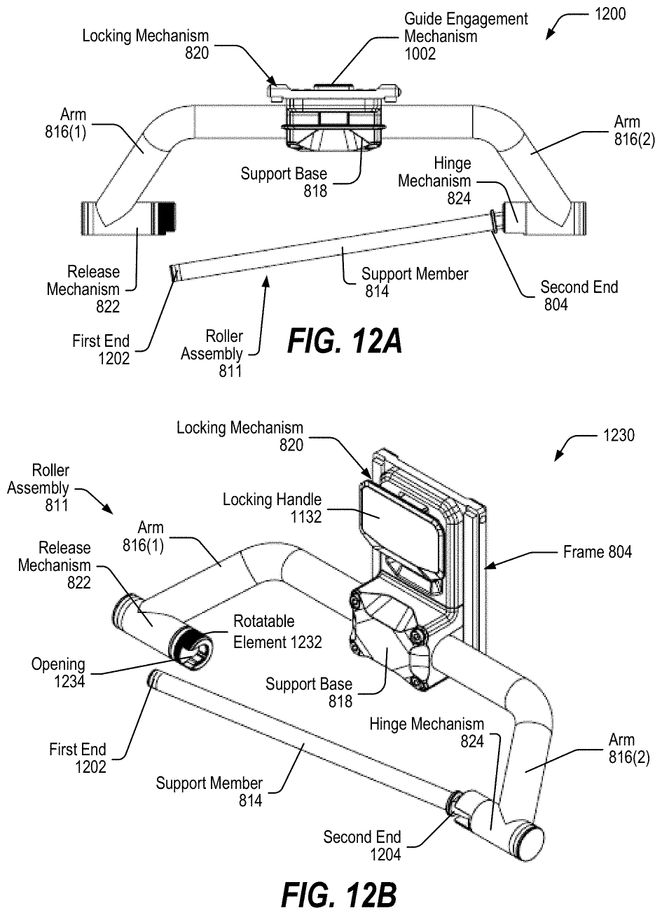

FIG. 12A depicts a top view 1200 of a roller assembly 811 including a roller support member 814 or arm pivoted about a hinge mechanism 824 to allow for selected mounting of a roller element or roller device 818, in accordance with certain embodiments of the present disclosure. The roller assembly 811 may include all of the elements of the roller assemblies of FIGS. 8A-11. The support member 814 may include a first end 802 configured to engage the release mechanism 822 in a closed state and to move away from the release mechanism 822 in an open state. The support member 814 may include a second end 804 coupled to the hinge mechanism 824 to allow the support member 814 to pivot about the hinge mechanism 824 to open and close to install or remove roller devices 818.

FIG. 12B depicts a perspective view 1230 of the roller assembly 811 of FIG. 12A showing a release mechanism 822 to release a first end 1202 of the support member 814 to enable selective installation of a roller element or roller device 818 on the support member 814. The release mechanism 822 may include a rotatable element 1232 including an opening 1234 on one side that may releasable engage the first end 1202 of the support member 814.

In some implementations, after installation of a roller device 818, the support member 814 may be pivoted about the hinge mechanism 824 toward the rotatable element 1232 until the first end 1202 passes into the opening 1234. The rotatable element 1232 may then be rotated to lock the first end 1202 in the release mechanism 822. Other implementations are also possible.

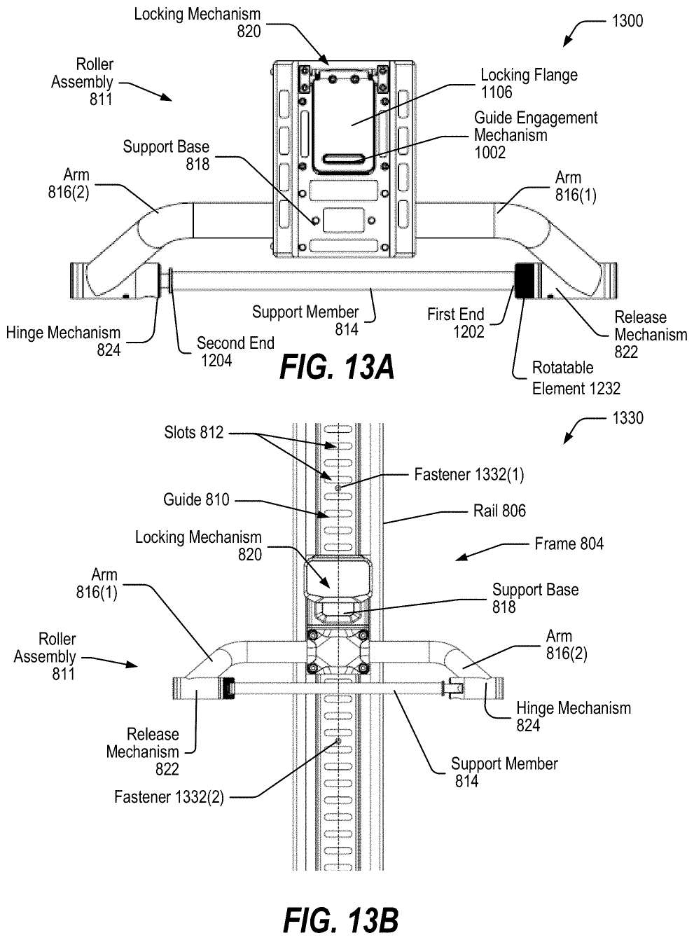

FIG. 13A depicts a rear view 1300 of an embodiment of a roller mounting assembly 811 including a locking mechanism 820 configured to releasably engage elevation locking features (such as slots 812) of a frame 804, in accordance with certain embodiments of the present disclosure. In this example, the first end 1202 of the support member 814 may be secured by the rotatable element 1232 of the release mechanism 822 in a closed state. Further, the locking flange 1136 and the guide engagement mechanism 1002 are shown.

FIG. 13B depicts an embodiment of a system 1330 including the elevation locking features (slots 812 of the guide 810) of the frame 804, in accordance with certain embodiments of the present disclosure. In this example, the roller assembly 811 is locked at approximately a middle portion of the frame 804.

In this example, in addition to the frame mount areas 808 in FIG. 8, the frame 804 may further include openings between the slots 812, which openings may be configured to receive a fastener 1332. In this example, the frame 804 is coupled to the support 802 by fasteners 1332(1) and 1332(2). Other implementations are also possible.

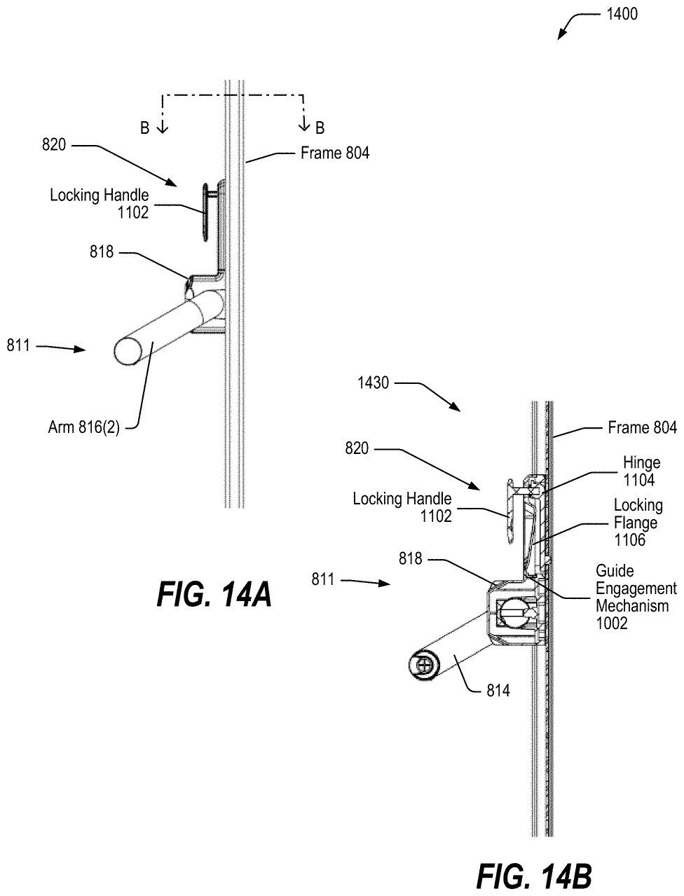

FIG. 14A depicts a side view 1400 of the system 800 of FIGS. 8A-13B with a handle 1102 of a locking mechanism 820 in a locked state, in accordance with certain embodiments of the present disclosure. In this example, the handle 1102 is pushed in and extends substantially parallel to the frame 804, which may cause the guide engagement mechanism 1002 to extend into or through one of the slots 812.

FIG. 14B depicts a cross-sectional view 1430 of the system 800 of FIG. 14A taken along line B-B. In this example, the locking handle 1102 is coupled to the locking flange 1106 by a hinge 1104. In this example, the locking handle 1102 is in a closed state such that the guide engagement mechanism 1002 may extend into or through one of the slots 812 to secure the roller assembly 811 to the frame 804.

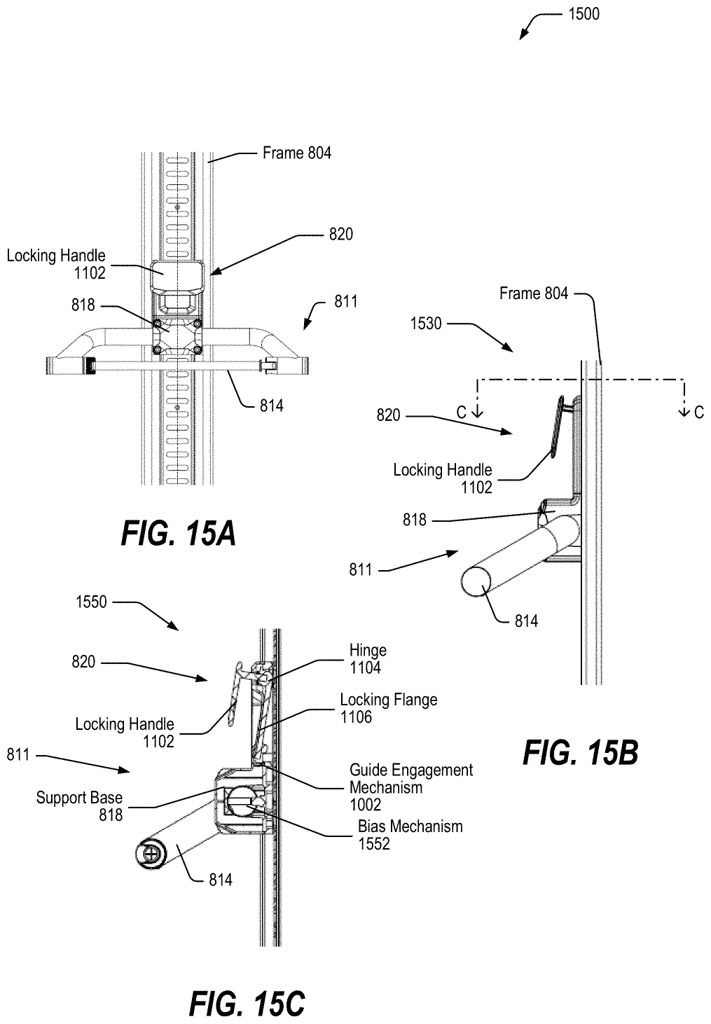

FIG. 15A depicts a front view 1500 of the system 800 including the frame 804 and the roller assembly 811 coupled to the frame 804 by a locking mechanism 820 with a handle 1102 of the locking mechanism 820 in an unlocked state, in accordance with certain embodiments of the present disclosure. In the front view 1500, the angle of the handle 1102 cannot be readily determined.

FIG. 15B depicts a side view 1530 of the system 800 of FIG. 15A. In this example, the locking handle 1102 extends at an angle greater than zero relative to the frame 804.

FIG. 15C depicts a cross-sectional view 1550 of the system 800 of FIG. 15B taken along line C-C. By pulling the locking handle 1102, the hinge 1104 pivots, causing the locking flange 1106 and the guide engagement mechanism 1002 to disengage the slots 812 of the frame 804.

In some implementations, the support base 818 may include a bias mechanism 1552, which may be configured to apply a force to one or more of the locking flange 1106, the guide engagement mechanism 1002, or another element to engage the slots 812 of the frame 804. When the locking handle 1102 is released, the bias mechanism 1552 may bias the guide engagement mechanism 1002 into or through one of the slots 812. Other implementations are also possible.

The support member 114 and the support member 814 may be substantially the same. Additionally, the release mechanism 822 and the hinge mechanism 824 may be incorporated in the roller assembly 111 in FIG. 1.

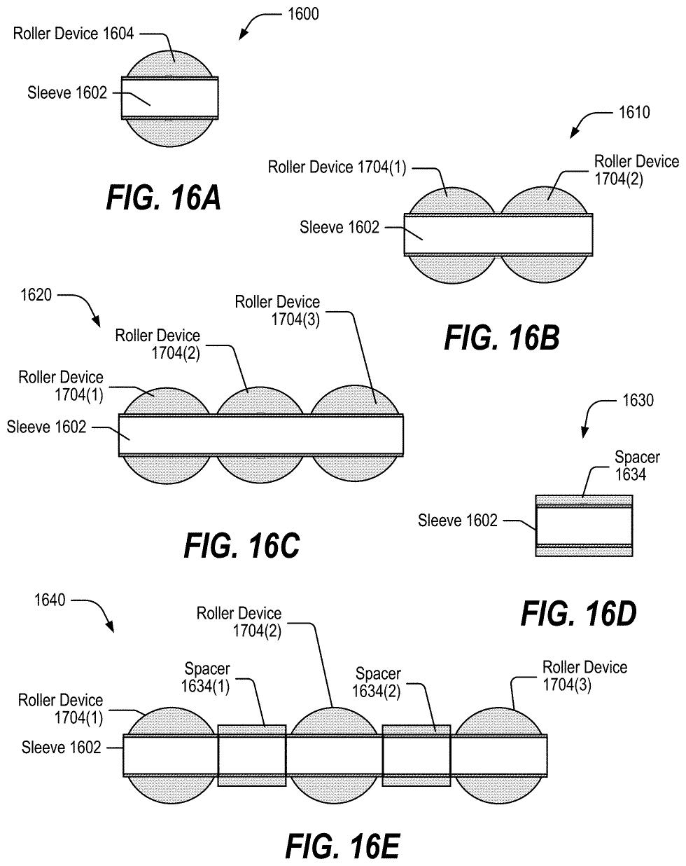

It should be appreciated that the support member 114 or 814 may be configured to support one or more roller devices 118 or 818. Spherical examples of roller devices are described below with respect to FIG. 16A-16E. However, other roller device shapes are also possible. Such shapes may include cylinders, spheres with corners or bumps, other shapes, or any combination thereof.

FIGS. 16A-16E depict embodiments of roller elements including roller balls, in accordance with certain embodiments of the present disclosure. In FIG. 16A, a single roller ball is shown, which may include a sleeve 1602 and a roller device 1604. The sleeve 1602 may be an opening configured to fit over and slide along the support member 114 in FIG. 1 or the support member 814 in FIG. 8. It should be appreciated that one or more roller ball devices 1604 may be coupled to the support member 114 or 814.

In the view presented by FIG. 16B, a pair of roller devices 1604 are shown, which may be coupled to the support mount 114 or 814. In this example, the roller devices 1604(1) and 1604(2) may be implemented as a single unit with a sleeve 1602. In an alternative embodiment, each roller device 1604 may have its own sleeve 1602. The sleeve 1602 may facilitate installation of one or more of the roller devices 1604 onto the support member 114 and may facilitate rotation of the one or more roller devices 118 or 918 about the support member 114 or 814.

In the view 1620 shown in FIG. 16C, three roller devices 1604(1), 1604(2), and 1604(3) are coupled to a sleeve 1602, which may fit onto the support member 114 or 814. It should be understood that, in some implementations, each roller device 1604 may have its own sleeve 1602.

In the view 1630 shown in FIG. 16D, a spacer 1634 is shown. The spacer 1634 may include a sleeve 1602, which may be sized to fit onto the support member 114 or 814. One or more spacers 1634 may be used in conjunction with one or more roller devices 1604 to provide a selected spacing.

In the view 1640 shown in FIG. 16E, three roller devices 1604 and two spacers 1602 are coupled to a sleeve 1602, which may be sized to fit onto the support member 114 or 814. Other combinations of roller devices 1604 and spacers 1602 may also be used. In alternative examples, roller devices 1604 may include three, four, or five roller devices 1604 coupled to a shared sleeve 1602. By spacing the roller devices 1604 using the spacers 1602, different areas of a user's back, leg, or other part of his or her body may contact the roller devices 1604 at the same time.

Though the roller devices 1604 are depicted as spheres, it should be appreciated that the roller devices 1604 may include cylindrical devices, devices with bumps, spikes, or knobs, or other irregularities. A user may install one or more roller devices 1604, spacers 1602, or other devices onto the support member 114 or 814 to provide a selected massage effect. Other implementations are also possible.

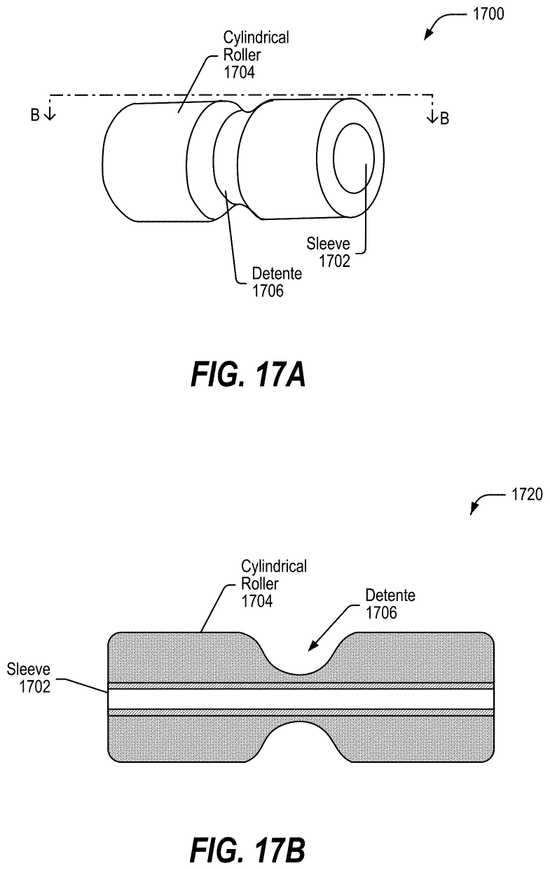

FIG. 17A depicts a foam roller accessory 1700 that can be used with any of the systems of FIGS. 1-16C, in accordance with certain embodiments of the present disclosure. The foam roller accessory 1700 may include a sleeve 1702, which may fit around and slide onto the support member 814. The foam roller accessory 1700 may be a cylindrical roller 1704 with a détente 1706 in a center portion. The foam roller accessory 1700, when installed on the support member 114, may be configured to rotate about the support member.

FIG. 17B depicts a cross-sectional view 1720 of the foam roller accessory 1700 of FIG. 17A taken along line B-B, in accordance with certain embodiments of the present disclosure. In the cross-sectional view 1720, the sleeve 1702 extends the entire length of the foam roller accessor 1700 with a constant diameter. The détente 1706 represents a change in the diameter of the cylindrical roller 1704 and is located at a center portion of the cylindrical roller 1704, but the détente 1706 does not extend to the depth of the sleeve 1702 within the foam roller accessor 1700.

In some implementations, the sleeve 1702 may be formed from metal, coated foam material, hardened material, plastic, a composite material, or another material. In some implementations, the sleeve 1702 may be formed by drilling a hole through the foam material of the foam roller accessory 1700 and the sleeve 1702 may be formed by the foam material itself. Other implementations are also possible.

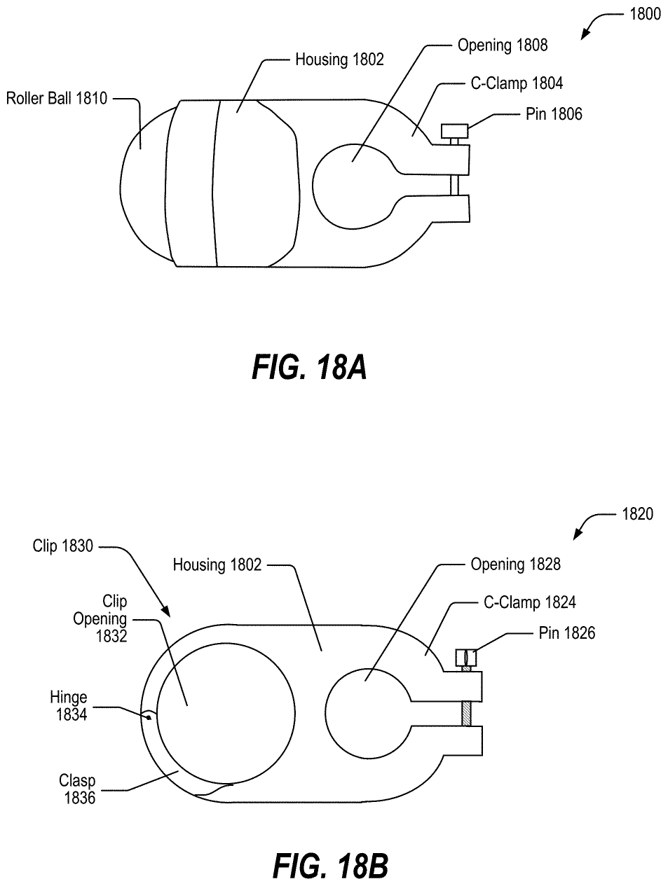

FIG. 18A depicts a side view of a force point roller assembly 1800 including a C-clamp and détente pin that can be used with any of the systems of FIGS. 1-15C, in accordance with certain embodiments of the present disclosure. The force point roller assembly 1800 may include a housing 1802 having a first portion that includes a c-clamp 1804 and having a second portion that includes a roller ball 1810.

The c-clamp 1804 may include an opening 1808 sized to fit around the support member 114. The c-clamp 1804 may include a fastener or pin 1806 that may be tightened to apply a compression force to the support member 114 to secure the force point roller assembly 1800 to the support member 114.

The roller ball 1810 may fit into a socket of the housing 1802, which may secure the roller ball 1810 to the housing 1802 while allowing the roller ball 1810 to rotate. A user may lean against the roller ball 1810 and move relative to the roller ball 1810 to receive a therapeutic or massage effect.

FIG. 18B depicts a side view of a clip or carabiner assembly 1820 that can be used with any of the systems of FIGS. 1-15C, in accordance with certain embodiments of the present disclosure. The carabiner assembly 1820 may include a housing 1802 having first portion that includes a c-clamp 1824 and having a second portion that includes a clip 1830. The c-clamp 1824 may include an opening 1828 configured to fit around the support member 114. The c-clamp 1824 may include a fastener or pin 1826, which may be tightened to apply a compression force to the support member 114 to secure the clamp 1824 in a selected orientation relative to the support member 114.

The clip 1830 may include a clip opening 1832, which may be partially enclosed by a portion of the housing 1802 and which may include a clasp 1836 coupled to the housing 1802 by a hinge 1834. The clasp 1836 may open by pivoting relative to the hinge 1834 to receive an object, such as an elastic band, a rope, a handle, or another component, and may close by pivoting relative to the hinge 1834 to secure the object.

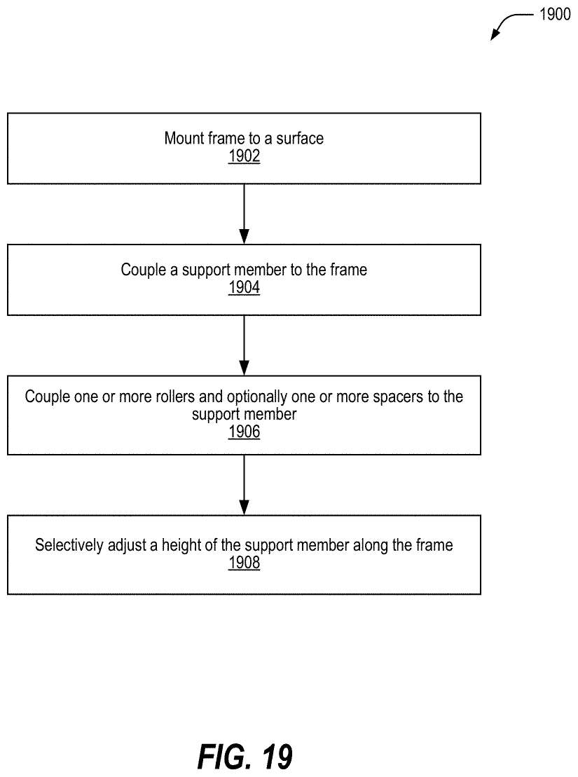

FIG. 19 is a flow diagram of a method 1900 of installing a system including a supporting assembly to secure and support one or more roller devices, in accordance with certain embodiments of the present disclosure. At 1902, the method 1900 may include mounting a frame to a vertical surface. For example, the frame may be mounted to a flat wall surface or to a corner between adjacent walls. The mounting of the frame may include securing a bracket mounting component to the surface, and securing a bracket associated with one of the legs of one of the rails to the bracket mounting component. Additionally, a fascia may be moved along the leg to cover the bracket mounting component to obscure the bracket attachment.

At 1904, the method 1900 may include coupling a roller support member to the frame. The roller support member may be coupled to the frame by a pair of handles, which may be releasably coupled to rails of the frame to move the roller support member up or down along the frame.

At 1906, the method 1900 may include coupling one or more rollers and optionally one or more spacers to the support member. In some examples, an end of the roller support member may be released from one of the handles and may be pivoted to provide access to the roller support member. One or more balls, rollers, or other devices may be coupled to the roller support member. In some implementations, the roller support member has a circular cross-section, and the interior of each of the balls, rollers, spacers, or other devices may include a cylindrical sleeve sized to receive the roller support member and to enable the ball, roller, or other device to rotate about the roller support member.

At 1908, the method 1900 may include selectively adjusting a height of the support member along the frame. In an example, the user may access a control option (such as a release mechanism, a button, a trigger, or any combination thereof) to release the handle from the frame to enable the user to slide the handle either up or down along the rail so that the user may adjust the height of the roller support member along the rails. In some implementations, the handle may include teeth or locking elements that may engage teeth or openings in the rail to secure the handle to the rail in a first mode and to release the handle to enable movement of the handle along the rail in a second mode. Other implementations are also possible.

In conjunction with the systems, methods, and devices described above with respect to FIGS. 1-20, a system is described that may include a frame and a roller assembly that may be releasably coupled to the frame. The frame may be mounted to a structure such as a wall on a flat surface or in or around a corner. The frame may include one or more rails including a plurality of slots, ridges, openings, or other engagement features. The roller assembly may include one or more locking mechanism configured to releasably engage one or more of the slots, ridges, openings, or other engagement features. The roller assembly may include one or more support bases coupled to the locking mechanism and configured to couple to the frame. The roller assembly may further include one or more arms extending from the one or more support bases and a support member that may be configured to be secured between the arms. The support member may be configured to secure a roller device. In some implementations, at least one end of the support member may be released from the arm to allow the roller devices to be changed.

In one implementation, the system may include a frame and a roller assembly. The frame may include a first rail and a second rail. Each rail may include a plurality of slots, openings, ridges, or other engagement features. The roller assembly may include a first side having a first support base and a second side having a second support base. Each support base may be configured to couple to one of the rails of the frame and to releasably engage one or more of the plurality of slots, openings, ridges, or other engagement features. Each support base may include an arm extending from the support base. The roller assembly may include a support member extending between arms. A first arm associated with a first support base may include a release mechanism to releasable engage a first end of the support member. A second arm associated with a second support base may include a hinge mechanism coupled to a second end of the support member to allow the support member to pivot about the hinge.

In some implementations, a system may include a frame and a roller assembly configured to releasably couple to the frame. The frame may include a plurality of slots, openings, ridges, or other engagement features. The frame may be coupled to a support, such as a wall, directly or via a bracket. The roller assembly may include a support base configured to couple to the frame and including a locking mechanism configured to releasably engage the slots, openings, ridges, or other engagement features. The roller assembly may include a first arm and a second arm that extend from the support base and away from the frame. The first arm may include a release mechanism and the second arm may include a hinge mechanism. The roller assembly may include a support member including a first end configured to releasably engage the release mechanism and a second end coupled to the hinge mechanism. The support member may be configured to selectively pivot about the hinge mechanism to open and close to allow for removal or installation of a selected roller device. Other implementations are also possible.

Although the present invention has been described with reference to preferred embodiments, workers skilled in the art will recognize that changes may be made in form and detail without departing from the scope of the invention.

What is claimed is:

1. A massage system comprising:
a frame configured to couple to a structure, the frame including one or more engagement features distributed along a length of the frame;
a roller assembly comprising:
a support base configured to couple to the frame;
a locking mechanism coupled to the support base and configured to releasably couple to at least one of the one or more engagement features of the frame;
at least one arm extending from the support base and away from the frame;
a support member coupled to the at least one arm; and
one or more massage devices configured to fit onto the support member.

2. The massage system of claim 1, wherein the one or more massage devices include one or more of a spherical roller, a spacer, a cylindrical roller, a roller including one or more ridges, or a roller including one or more bumps.

3. The massage system of claim 1, wherein the locking mechanism comprises:
a handle;
a hinge coupled to the handle;
a flange coupled to the hinge; and
a guide engagement mechanism configured to releasably engage the at least one of the one or more engagement features of the frame; and
wherein when the handle is:
in a first position, the guide engagement mechanism is configured to extend into or through the at least one of the one or more engagement features; and
in a second position, the guide engagement mechanism is configured to apart from the at least one of the one or more engagement features.

4. The massage system of claim 1, wherein the at least one arm comprises:
a first arm including a first end coupled to the support base and including a second end including a release mechanism configured to releasably engage a first end of the support member; and
a second arm including a first end coupled to the support base and including a second end including a hinge mechanism configured to couple to a second end of the support member.

5. The massage system of claim 4, wherein the first end of the support arm may move away from the release mechanism to change the one or more roller devices.
one or more of a roller device, a spacer, or a clip configured to be selectively coupled to the body portion of the support member; and
wherein the first trigger handle and the second trigger handle are movable along a length of the first rail and the second rail, respectively, to adjust a height of the support member.

6. The massage system of claim 1, wherein:
the frame includes a first rail and a second rail; and
the support base comprises:
a first trigger handle configured to releasably couple to the first rail, the first trigger handle including a first control option accessible by a user to cause the first trigger handle to selectively engage or release the first rail; and
a second trigger handle configured to releasably couple to the second rail, the second trigger handle including a second control option accessible by the user to cause the second trigger handle to selectively engage or release the second rail.

7. The massage system of claim 6, wherein each of the first trigger handle and the second trigger handle comprises a plurality of retractable teeth responsive to selection of the control option to retract to enable movement of the trigger handle relative to the one of the first rail or the second rail and responsive to release of the control option to engage the one of the first rail or the second rail to lock the trigger handle at a selected position.

8. The massage system of claim 6, wherein:
the first trigger handle comprises a spring-loaded catch to selectively engage a first end of the support member a first state and to disengage the first end in a second state; and
the second trigger handle comprises a hinge coupled to the second end of the support member to enable the support member to rotate about the hinge to facilitate installation or removal of the one or more massage devices in the second state.

9. The massage system of claim 1, wherein each of the one or more massage devices comprises:
a sleeve sized to fit around and rotate about the support member; and
a body portion extending around the sleeve, the body portion comprising one or more of a smooth sphere, a sphere including one or more ridges or bumps, a smooth cylinder, a cylinder including one or more ridges or bumps, a spacer, or a geometric shape.

10. The system of claim 9, wherein the body portion is formed from one or more of a rubber material, a plastic material, a foam material, or a composite material.

11. The system of claim 1, wherein the one or more massage devices comprises a housing including:
a first end having a c-clamp configured to releasably couple to the support member; and
a second end including one of a roller ball or a hook.

12. A system comprising:
a frame configured to couple to a structure and including engagement features distributed along a length of the frame;
a roller assembly configured to couple to the frame, the roller assembly including a support member configured to open to receive and secure one or more massage elements; and
wherein the one or more massage elements include one or more of a sphere, a cylinder, or a spacer.

13. The system of claim 12, wherein the roller assembly comprises:
a support base configured to couple to the frame;
a locking mechanism coupled to the support base and configured to releasably couple to at least one of the one or more engagement features of the frame;
at least one arm extending from the support base and away from the frame;
wherein the support member is coupled to the at least one arm.

14. The system of claim 12, wherein the one or more massage devices include one or more a ridge or a bump.

15. The system of claim 12, wherein the one or more massage devices comprises a housing including:
a first end having a c-clamp configured to releasably couple to the support member; and
a second end including one of a roller ball or a hook.

16. The system of claim 12, wherein the roller assembly includes a locking mechanism comprising:
a handle;
a hinge coupled to the handle;
a flange coupled to the hinge; and
a guide engagement mechanism configured to releasably engage one or more of the engagement features of the frame in response to movement of the handle.

17. The system of claim 12, wherein the roller assembly comprises:
a support base;
a first arm including a first end coupled to the support base and including a second end, the second end including a release mechanism configured to releasably engage a first end of the support member; and
a second arm including a first end coupled to the support base and including a second end, the second end of the second arm including a hinge mechanism configured to couple to a second end of the support member; and
wherein the first end of the support arm may move away from the release mechanism to change the one or more roller devices.

18. The system of claim 12, wherein:
the frame includes a first rail and a second rail; and
the roller assembly comprises:
a first trigger handle configured to releasably couple to the first rail, the first trigger handle including a first control option accessible by a user to cause the first trigger handle to selectively engage or release the first rail; and
a second trigger handle configured to releasably couple to the second rail, the second trigger handle including a second control option accessible by the user to cause the second trigger handle to selectively engage or release the second rail.

19. A system comprising:
a frame configured to couple to a structure, the frame including a plurality of engagement features distributed along a length of the frame;
a roller assembly coupled to the frame, the roller assembly comprising:
a support base configured to couple to the frame;
a locking mechanism coupled to the support base and configured to selectively couple to one or more of the plurality of engagement features;
a first arm including a first end coupled to the support base and including a second end including a release mechanism, the arm extending away from the support base;
a second arm including a first end coupled to the support base and including a second end including a hinge mechanism, the arm extending away from the support base; and
a support member including a first end to releasably couple to the release mechanism and including a second end coupled to the hinge mechanism, the support member configured to receive one or more massage devices.

20. The system of claim 19, wherein the one or more massage devices comprises one or more of a spherical roller, a cylindrical roller, a device including a first end having a c-clamp and a second end including a carabiner clip, or a device including a first end having a c-clamp and a second end including a spherical roller.
